(19) United States
(12) Patent Application Publication
(10) Pub. No.: US 2019/0059396 A1
(43) Pub. Date: Feb. 28, 2019

(54) Whey Protein-Based Cookie Doughs and Cookie Products

(71) Applicant: Tucker Smith, Twin Falls, ID (US)

(72) Inventor: Tucker Smith, Twin Falls, ID (US)

(21) Appl. No.: 16/116,743

(22) Filed: Aug. 29, 2018

Related U.S. Application Data
(60) Provisional application No. 62/551,589, filed on Aug. 29, 2017.

(51) Int. Cl. A21D 2/26; A21D 13/80; A21D 10/00

(52) U.S. Cl. CPC A21D 2/263; A21D 13/80; A23V 2200/122; A23V 2002/00; A23V 2250/54252; A21D 10/005

(57) ABSTRACT

Disclosed are whey protein-enriched cookie dough and cookie products. Also disclosed is a method for making whey protein-enriched cookie doughs and cookies.

The present application claims the benefit of priority of U.S. Provisional Patent Application No. 62/551,589, filed Aug. 29, 2017.

### FIELD OF THE INVENTION

The present invention relates to doughs comprising whey protein, and baked goods made therefrom. The invention also relates to protein-enriched cookie doughs and cookie products.

### BACKGROUND OF THE INVENTION

Adults and children around the world love cookies, also known as biscuits, which are small relatively flat, or slightly raised, bakery products. Just as popular, especially in recent years, is the dough from which the cookies are made. In fact, unbaked (i.e., “raw”) cookie dough has become so popular that companies now produce it for direct consumption as an unbaked product, with several companies making tubs of dough that are sold in specialty shops, in grocery stores, and/or online. Cookie dough is also incorporated into other products, such as ice cream. Homemade cookie doughs generally contain eggs, so consumption of the raw cookie dough has been discouraged, leading to efforts to produce cookie doughs that are eggless, more food-safe, and perhaps enriched with added nutrients. Many “cookie dough” products that have been developed for direct consumption as raw products contain ingredient modifications that result in a dough that cannot actually be used to produce a suitable cookie if the dough is baked, limiting their commercial market potential.

Because cookie dough can be provided in various flavors—such as, for example, chocolate chip, sugar cookie, peanut butter cookie, snickerdoodle, etc.—and can be packaged in single-serving sizes or multiple-serving sizes, it is a product that can be formulated to meet specific nutritional needs in a convenient and highly-palatable form. For example, among the nutrient-enriched cookie dough products are products such as fiber-enriched cookie doughs and protein-enriched cookie doughs. Ideally, such a cookie dough product would maintain the same consistency and taste as a standard cookie dough that would be used to make chocolate chip, peanut butter, or other cookies, would be stable for an extended period of time under refrigeration and/or at room temperature, and would, if baked at the appropriate temperature, provide one or more cookies that would have the appropriate shape, texture, and taste corresponding to the type of dough used.

One type of protein that would be especially beneficial in a protein-enriched cookie dough product is whey protein. Whey protein is a source of complete protein, containing all of the essential amino acids. It is highly digestible, and higher in leucine than most other protein sources. Protein is important for growth, muscle development, wound-healing, maintaining fluid/electrolyte balance, and multiple other functions. Protein-enriched foods have especially been recommended for growing children, for athletes who want to build and maintain muscle mass, and for the elderly, who are at risk of losing muscle mass—and becoming correspondingly weaker, physically—as they age.

Whey protein supplements have traditionally been provided in the form of protein powder, which can be mixed into water, juice, etc. However, in recent years the market for high-protein snack foods has been growing. Snacks such as protein bars, cookies, crisps, and pudding-type products, for example, are attractive because they do not require the addition of liquid by the consumer, and can be packaged in individual portions that can easily be carried in a gym bag, backpack, or even in the pocket of clothing, such as a jacket pocket,

Cookies and cookie dough products have been made using protein sources such as chickpeas and black beans, as well as vegetable protein powders, such as soy and/or pea powders, but there appears to be a general consensus that whey protein presents formulation issues that can make it undesirable as a protein source for protein-enriched cookie doughs and cookies. One source suggests that a cookie dough mixture should be “no more than ⅛ protein powder, especially if you use whey. Otherwise, the whey will cook and your cookies will turn out rubbery and weirdly bread-like.” (Anna Sward, Ask the Protein Powder Chef: Do You Have A Recipe for Protein Chocolate Chip Cookies? February 2017, https://www.bodybuilding.com /fun/ask-the-protein-powder-chef-protein-chocolate-chip-cookies.html) Another suggests that whey protein should not be substituted for plant-based protein in a cookie dough recipe because doing so will result in a cookie dough that is “runny, sticky, and gooey” (Amy's Healthy Baking blog, Single-Serving Chocolate Chip Protein Cookie Dough, http://amyshealthybaking.com/ blog/2016/07/12/single-serving-chocolate-chip-protein-cookie-dough).

Aymard, et al. (WO2016/038184) disclosed a biscuit/cookie comprising at least 8 weight percent protein wherein the biscuit comprises native whey protein in an amount of at least 0.5 percent by weight of the dough, and viscous soluble fibers and/or insoluble fibers in an amount of from 5 to 20 percent by weight. They found that fiber-enriched doughs required more water to produce a workable dough, but using intact whey protein in a fiber-enriched cookie/biscuit product decreased the amount of added water that was needed in order to have a workable dough. However, as they explain on page 18, at lines 5-11, as the whey protein is increased to above 8 percent, the dough becomes undesirably sticky.

Protein-enriched cookie dough and protein-enriched cookies made from the dough could be both convenient and highly-palatable, making them ideal snack foods, and especially ideal snack foods for athletes, growing children, and older individuals. What is needed is a method for making protein-enriched cookie dough using whey protein that will produce a cookie dough with the desired taste, texture and cohesiveness to make the dough pleasant to eat.

### SUMMARY OF THE INVENTION

The invention relates to a whey protein-enriched cookie dough comprising whey protein phospholipid concentrate. In various embodiments, the whey protein-enriched cookie dough comprises at least about 18 percent of a whey protein ingredient by weight of the dough, the whey protein ingredient comprising at least about 50 percent whey protein phospholipid concentrate. In various embodiments, the cookie dough is eggless. In various embodiments, the cookie dough is flourless. In various embodiments, the whey protein ingredient comprises at least about 75 percent whey protein phospholipid concentrate by weight, with the remainder of the whey protein ingredient comprising whey protein from a source selected from the group consisting of whey protein concentrate (e.g., WPC80), whey protein isolate, milk protein concentrate, milk protein isolate, and combinations thereof.

The invention also relates to an eggless shelf-stable cookie dough, the cookie dough comprising whey protein phospholipid concentrate and at least one non-viscous soluble fiber as ingredients of the dough. In various embodiments, the non-viscous soluble fiber is added to the cookie dough as a syrup. In various aspects of the invention, the whey protein phospholipid concentrate is present in the cookie dough in an amount of at least about 18 percent by weight of the cookie dough.

The invention also relates to a method for making a high-protein cookie dough comprising whey protein, the method comprising adding to an admixture of dough ingredients at least about 18 percent by weight of a whey protein ingredient comprising at least 50 percent whey protein phospholipid concentrate. In various embodiments, the whey protein ingredient comprises at least about 75 percent whey protein phospholipid concentrate by weight.

The invention relates to a whey protein-enriched cookie comprising whey protein phospholipid concentrate. In various embodiments, the whey protein-enriched cookie comprises at least about 18 percent by weight of a whey protein component comprising at least about 50 percent whey protein phospholipid concentrate. In various embodiments, the cookie is eggless. In various embodiments, the cookie is flourless. In various embodiments, the whey protein component comprises at least about 75 percent whey protein phospholipid concentrate by weight.

The invention also relates to an eggless shelf-stable cookie, the cookie comprising whey protein phospholipid concentrate and at least one non-viscous soluble fiber. In various aspects of the invention, the whey protein phospholipid concentrate is present in an admixture of cookie dough ingredients in an amount of at least about 18 percent by weight of the cookie dough.

The invention also relates to a method for making a protein-enriched cookie comprising whey protein, the method comprising adding to an admixture of dough ingredients at least about 18 percent whey protein phospholipid concentrate by weight of the dough.

### BRIEF DESCRIPTION OF THE DRAWINGS

FIG. 1 is a photograph of a high-protein cookie dough product of the invention.

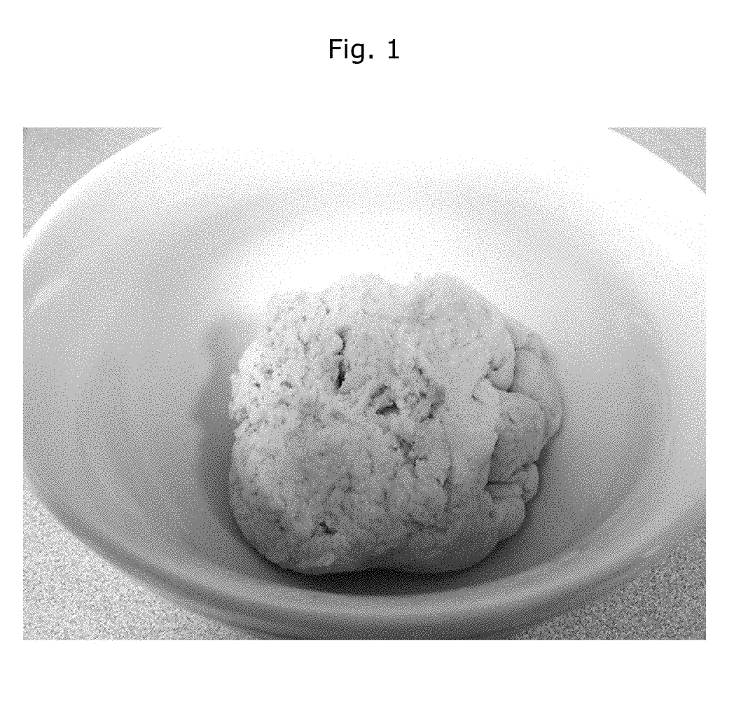

FIG. 2 is a photograph of a high-protein cookie product of the invention, made with WPPC.

FIG. 3 is a photograph of a high-protein cookie made using milk protein concentrate (MPC), which contains casein in addition to whey protein, but does not share the same concentration of MFGM as found in WPPC.

### DETAILED DESCRIPTION

The inventors have discovered that by utilizing whey protein phospholipid concentrate (WPPC) in whey protein-enriched cookie and/or cookie dough product, a whey protein-enriched cookie and/or cookie dough product can be produced while avoiding the undesirable product properties that have previously been described when whey protein is used to produce these products (e.g., runny, sticky, gooey). The inventors have developed cookie dough products using whey protein phospholipid concentrate that have texture, taste, mouthfeel, and other attributes similar to those of homemade cookie dough. Cookie dough products made by the inventors have also been baked to produce cookies having the taste, crispness, moistness, chewiness, and spread common to cookies made using standard ingredients such as flour, shortening, sugar, leavening agents (e.g., baking powder, baking soda), and eggs.

Where “comprising” is used herein, it should be understood that “consisting of” and/or “consisting essentially of” may also be used. Where “at least about 50 percent” is stated, for example, it should be understood that “at least about 60 percent,” at least about 70 percent,” etc., are also included within “at least about 50 percent” as limitations which are suitable descriptions of the amounts appropriate for use in the invention. A “whey protein component,” as used herein, is the fraction of the ingredients of a cookie dough and/or cookie that contains whey protein, which can be added as one ingredient containing 100% WPPC, or an admixture of WPPC and whey protein from one or more other sources (e.g., MPC, MPI, WPC, WPI), or added separately as WPPC and the appropriate amount of whey protein from another source such as MPC, MPI, WPC, and/or WPI, for example. Unless otherwise indicated, percentages of ingredients are calculated by weight.

Whey protein phospholipid concentrate (WPPC), also known in the dairy industry as high-fat whey protein concentrate (HFWPC), is a concentrated whey protein product retained from the production of whey protein isolate. Whey is often converted to whey protein concentrate by ultrafiltration. Whey protein concentrate 80 (containing 80% protein on a dry matter basis) is manufactured by extensive ultrafiltration and diafiltration of crude whey, for example. Although whey protein concentrates can have different levels of protein, the widely-used whey protein concentrate 80 (WPC80) typically contains about 80 to 82% protein, 4 to 8% lactose, and 4 to 8% fat, while whey protein isolate (WPI) typically contains 90.0%-92.0% protein, 0.5%-1.0% lactose, and 0.5%-1.0% fat. (Reference Manual for U.S. Whey and Lactose Products, USDEC (2008), p. 33). To produce WPC80 concentrate, liquid whey is first concentrated 20× to 30 by ultrafiltration, giving a solids content of about 25%. Raw whey nay also be concentrated using reverse osmosis to increase the solids concentration, then using ultrafiltration to further purify those solids. The concentrate is then processed by diafiltration (adding water to the feed during filtration) to wash out lactose and ash (minerals).

Another type of whey protein concentrate, whey protein phospholipid concentrate (WPPC), is made by collecting the retentate from whey protein isolate manufacturing. The microfiltration (MF) process produces a permeate, containing the defatted whey protein (WPI), and a retentate which contains milk fat globule membranes (MFGM), residual fat, mineral, lactose and residual protein that did not permeate through during microfiltration. The WPI (MF permeate) undergoes further processing to concentrate the protein, which is then spray-dried before packaging. The retentate may also be further ultra-filtered to remove lactose and some minerals and then dried, producing a high-fat WPC powder (WPPC). It should also be noted that unlike the protein in the WPC product, which is collected as a retentate using a membrane that is selected to retain the protein, the protein that remains with the WPPC product is collected in the retentate using a membrane that is selected to allow the protein to pass through in the permeate, WPC and WPPC products therefore generally differ in fat and protein content.

WPPCs for use in the cookie doughs and cookies of the present invention include, for example, Salibra® 700 from Glanbia Nutritionals, Inc., Monroe, Wis. USA. Protein level and levels of other components of Salibra® 700 are shown in Table 1.

TABLE 1

| | |
|---|---|
| Protein, dry basis | >73% |
| Immunoglobulins | >5.0% |
| Lactoferrin, as is | >2.0% |
| IGF-1 | >10 ug/100 g |
| TGF-B1 | >1.5 ug/100 g |
| TGF-B2 | >35 ug/100 g |
| Sphingomyelin | >5.0 mg/g |
| Moisture | <5.5% |
| Fat | <15% |
| Phospholipids | >2.5% |
| Phosphatidylserine | >2.0 mg/g |
| Phosphatidylcholine | >6.0 mg/g |
| Conjugated Linoleic Acid | >1.5 mg/g |
| Minerals | <5.0% |
| pH | 6.0-7.0 |

The American Dairy Products Institute standard for WPPC (HFWPC) composition is a minimum of 50% protein (dry basis), a minimum of 12% fat, a maximum of 8% ash, and a maximum of 6% moisture. However, the characteristics and composition of WPPC depend on both the starting whey and the process for whey protein separation, so “whey protein phospholipid concentrate,” as used herein, refers to a whey protein concentrate collected in the retentate during the production of whey protein isolate, using a membrane that is selected to allow the protein to pass through in the permeate to isolate the whey protein for the whey protein isolate, While not being bound by theory, the inventors' experiments have indicated that the presence of the milk fat globule membrane fraction (MFGM) at enriched levels in the WPPC may contribute to the effect provided by the WPPC in the making of protein-enriched cookie dough and protein-enriched cookies. Therefore, given the fact that MFGM fractions can be isolated from WPCs, one of skill in the art could, given the information provided in the present disclosure, add back MFGM to whey protein in appropriate proportions to produce a WPPC-like product having the desirable effects of WPPC for use in the present invention.

“Protein-enriched,” as used herein, refers to a protein level that is higher than the protein level of a standard cookie dough (e.g., about 1% by weight) comprising, for example, butter, sugar, eggs, milk, all-purpose flour, vanilla extract, baking powder, and salt. Even more preferably, “protein-enriched” refers to a protein level that is higher than at least about 10 percent protein by weight of the cookie dough.

In recent years, a significant amount of research has focused on new uses for WPPC because it represents about 14 to 18 percent of the total whey processed annually, but has generally been considered more of a disposable by-product than a commercially-valuable product of dairy manufacturing. The list of products for which WPPC has been suggested to be a beneficial ingredient has, however, been growing—and includes products such as ice cream, frozen yogurt, beverages, salad dressings, process cheese, protein bars, and infant formulas. WPPC has also been suggested to be potentially useful as an egg replacer in cakes.

Cookie doughs must be stiff enough to maintain their shape because, unlike cakes, cookies are generally baked without the use of a mold to hold the ingredients in place during the baking process. Cookie ingredients are generally selected because they contribute not only to the taste of the cookie, but also to the requisite crispness, moistness, chewiness, and spread of the resulting cookie, with spread being the most frequent cause of variation in cookie quality. Fats, for example, aid in incorporation of air into the dough, contribute to the consistency and thickness of the doughs, and modify cookie spread. Sugars effect the final cookie structure by affecting the gelatinization temperature of the starch in the mix. Optimally, cookie dough should be cohesive, with minimal elasticity. Whey protein tends to decrease the amount of water that must be added to a higher-fiber cookie, and cookie doughs with significant amounts of whey protein have generally been described as runny, sticky, and gooey. The inventors, however, have discovered that if the whey protein is added in a form comprising (e.g., as an ingredient comprising) whey protein phospholipid concentrate, the cookie dough has the requisite cohesiveness and minimal elasticity, rather than being runny, sticky, or gooey. Furthermore, if a cookie dough product of the invention is baked to make cookies, the cookies have the desired crispness, moistness, chewiness and spread.

As noted previously, earlier efforts to incorporate whey proteins into products such as cookie doughs and cookies have, if the whey protein level is high enough to produce a desirable “high protein” product, produced disappointing results. Cookies made using significant amounts of whey protein tend to be rubbery and bread-like, while if cookie dough is made with significant amounts of whey protein, it tends to be runny, sticky, and gooey. WPPCs have been incorporated into products such as ice cream, frozen yogurt, beverages, salad dressings, process cheese, protein bars, and infant formulas. However, formulating these types of products presents different challenges than does formulating cookie doughs and cookies. One group recently described the use of WPPC as a substitute for eggs in cake formulations (Levin, M. A. et al, Whey protein phospholipid concentrate and delactosed permeate: Applications in caramel, ice cream, and cake. J. Dairy Sci. (2016) 99: 6948-6960). However, in order to replace the 12.2 percent of the ingredient panel that comprised eggs, they only used approximately 2 to 2.5 percent WPPC by weight. A higher protein level is desired for protein-enriched cookie doughs and cookies, and from these results it would appear that the addition of a sufficient amount of WPPC to increase the protein level could negatively impact the structure of the cookie dough and/or cookie. Eggs serve several purposes in baking, including adding structure, color, flavor, leavening and firmness. As eggs cook, they become firm. The firmness helps to set the physical structure of cookies. Therefore, increasing the amount of WPPC in a cookie could, based on the disclosure of Levin et al. describing WPPC as a potential egg substitute in certain products, create an undesirable effect in terms of texture, structure, and taste. The inventors have not found that to be the case, however, and their formulations are whey protein-enriched while being structurally and texturally cookie dough-like and pleasant-tasting.

The inventors have found that significantly higher amounts of whey protein can be incorporated into cookie dough using WPPC, either as the single source of whey protein or in conjunction with other sources of whey protein such as, but not limited to, whey protein concentrate and whey protein isolate. WPPC can, if such a product is desired, produce a cookie dough in the absence of both eggs and flour, and not only does the cookie dough possess the taste and texture/consistency that a consumer would expect and desire of cookie dough, but the dough can also be used to produce a high-protein cookie with the desired taste and texture/consistency of a cookie. Cookie dough made by the method of the invention can be formulated to be shelf-stable without refrigeration, and if no flour is added, it can also be formulated as a gluten-free product.

Formulators may wish to add eggs and/or flour to the dough—particularly when it is expected to be used to produce baked cookies—but it may be preferable in many cases to leave out both eggs and flour from the cookie dough ingredient panel. Therefore, one embodiment of the invention is an eggless, flourless, high-protein, shelf-stable cookie dough that has both the taste and consistency that a consumer would expect of a cookie dough. By using WPPC as the whey protein source, the inventors have developed a way to incorporate significant (e.g., from about 18 to about 30 percent, by weight) amounts of whey protein into a cookie dough product without producing a runny, sticky, and/or gooey product such as has described to be the result when whey protein has been incorporated into cookie dough products in the past.

The inventors have discovered that superior results are obtained when WPPC comprises higher percentages in the whey protein component of the dough. For example, at levels at or below 75 percent of WPPC in the dough, using milk protein concentrate (MPC) or whey protein isolate (WPI) as the additional source of whey protein in the whey protein component, doughs tended to be more sticky, gummy, or viscous than doughs produced using 100 percent WPPC in the whey protein component or a 95% WPPC/5% MPC blend, for example. Similarly, increasing the percentage of WPC80, WPI, MPC, and/or MPI in the whey protein component comprising WPPC increased the structure and dryness of the resulting cookies. Those of skill in the art will recognize that since cookies, particularly, contain other ingredients (e.g., peanut butter, oatmeal, etc.), some may also wish to add small amounts of other types of proteins such as, for example, plant-based proteins, whey proteins, milk proteins, etc., to cookie doughs and/or cookies of the invention in order to adjust the texture, crispness, etc., of one or more types of cookies made according to the method of the invention, provided that WPPC comprises a significant and functionally effective, percentage of the protein component.

Viscous soluble fiber and insoluble fiber have previously been incorporated into a whey protein-containing cookie dough, but the dough became sticky at a whey protein level of from about 8 to about 12 percent (Aymard, et al., WO2016/038184). In order to better control the water activity of a cookie dough of the present invention to produce a dough that does not require refrigeration and/or is shelf-stable, the inventors have utilized a syrup comprising non-viscous soluble fiber (iso-maltooligosaccharide). Cookie doughs comprising WPPC and non-viscous soluble fiber are therefore also contemplated in various embodiments of the invention. Iso-maltooligosaccharide syrup, for example, can be commercially obtained from BioNeutra North America Inc., Edmonton, Alberta, Canada.

By using WPPC as a whey protein source, the inventors have also developed a way to produce a high-protein cookie that actually tastes like a cookie and has the mouthfeel of a cookie. These types of cookies can also be eggless and flourless,

shelf-stable, and gluten-free. They incorporate both the nutritional advantages of whey protein (higher levels of leucine, complete amino acid profile, etc.), as well as the nutritional advantages provided by the milk fat globule membrane (e.g., omega-6 and omega-3 fatty acids).

Table 2 lists the nutritional profiles of a cookie dough of the present invention (Dough A), as well as two commercially-available refrigerated sugar cookie doughs (Dough B, Pillsbury® and Dough C, Nestle®). The cookie dough of the present invention (Dough A) has a similar taste and consistency to that of Doughs B and C, while containing 7x the amount of protein as Doughs B and C, Dough A containing 24 percent protein per serving.

TABLE 2

| | Dough A | Dough B | Dough C |
|---|---|---|---|
| Serving Size | 29 g | 29 g | 19 g (29 g) |
| Total Fat | 4 g | 5 g | 3.5 g (5 g) |
| Saturated Fat | 2.5 g | 1.5 g | 1.5 g (2 g) |
| Cholesterol | 45 mg | 5 mg | 5 mg (8 mg) |
| Sodium | 90 mg | 95 mg | 60 mg (90 mg) |
| Total | 14 g | 18 g | 11 g (16.5 g) |
| Carbohydrate | | | |
| Dietary Fiber | 4 g | 0 g | 0 g (0 g) |
| Total Sugars | 5 g | 11 g | 5 g (7.5 g) |
| Protein | 7 g | 1 g | 1 g (1.5 g) |

Cookie dough products of the invention provide an attractive snack option for athletes, who can readily carry the product with them in pouches or tubs, for example, to provide a quick high-protein snack. Such products can also be beneficial for children, and for the elderly, whose nutritional needs for protein may be higher than for the average adult. Cookie dough products of the invention could, for example, be supplied to children or adults in the types of containers which are often used for single servings of pudding, applesauce, etc.—plastic cups with foil lids—to provide a single serving of high-protein cookie dough that is shelf-stable, gluten-free, etc., depending upon how it is formulated, with preferred formulations being eggless and flourless formulations, the WPPC providing the properties within the dough formulation that are usually provided by eggs and flour.

Cookies made using WPPC at a level of from about 18 percent to about 30 percent of the ingredient formulation, by weight, can be provided in packages containing multiple cookies (e.g., one or two dozen cookies), or in smaller packages containing single-serving size portions of cookies which can be contained in small canisters, foil or plastic sleeve packaging, etc. These may be readily stored and carried in lunch boxes, gym bags, pockets, purses, etc. to provide high-protein snacks in the form of delicious cookies that provide both the benefits of whey protein and the benefits of the lipids and lipoproteins of milk. For example, dietary milk fat globule membrane (MFGM) supplementation combined with regular exercise improves skeletal muscle strength (Soqa, S., et al. Dietary milk fat globule membrane supplementation combined with regular exercise improves skeletal muscle strength in healthy adults: a randomized double-blind, placebo-controlled, crossover trial. Nutr J. 2015 Aug. 25; 14(1): 85). Components of the milk fat globule membrane have been suggested to have anti-cancer benefits, cholesterol-lowering effects, and anti-bacterial effects (Spitzburg, Invited Review: Bovine Milk Fat Globule Membrane as a Potential Nutraceutical. J. Dairy Sci. 88:2289-2294). Results of at least one study indicate that MFGM supplementation to infant formula narrows the gap in cognitive development between breastfed and formula-fed infants (Timby, N., et al. Neurodevelopment, nutrition, and growth until 12 mo of age in infants fed a low-energy, low-protein formula supplemented with bovine milk fat globule membranes: a randomized controlled trial. Am J Clin Nutr. 2014 April; 99(4):860-8). Cookie doughs and cookies of the present invention can therefore provide even more potential health benefits than those provided by whey protein alone.

One interesting study by Rosqvist et al. (Rosqvist, F. et al., Potential role of milk fat globule membrane in modulating plasma lipoproteins, gene expression, and cholesterol metabolism in humans: a randomized study. Am. J. Clin. Nutr. (2015) 102: 20-30) indicated that the presence of MFGM in dairy products may counteract the hypercholesterolemic effects of saturated fat. Butter, a common ingredient in cookie dough, is low in milk fat globule membrane. The butter-making process removes most of the MFGMs from the fat: In WPPC, MFGM binds to whey protein aggregates that are retained during the process of producing WPI from WPC. While the majority of triglycerides from milk are removed during skimming, cheesemaking, and whey cream removal, the MFGM remains associated with some of the whey proteins, especially those that form aggregates that are retained during the filtration process. The WPPC product is therefore enriched in MFGM.

The invention may be further described by means of the following non-limiting examples.

### EXAMPLES

Cookie Dough and Cookies Produced from the WPPC (HFWPC) Cookie Dough

Ingredients are listed in Table 3 for a shelf-stable cookie dough that does not require refrigeration.

TABLE 3

| Ingredient | Amount (g) |
|---|---|
| Butter | 70 |
| Sugar, Brown | 70 |
| Apple sauce | 15 |
| DP3 Fiber (Iso-maltooligosaccharide) | 95 |
| Syrup | |
| Sorbitol | 30 |
| Glycerine | 50 |
| Concentrated Whey Protein (80% | 140 |
| protein, WPPC) | |
| Acid casein | 10 |
| Vanilla extract | 2.5 |
| Natural and artificial flavors | 3.0 |
| Baking Soda | 1.3 |
| Sucralose | 1.5 |
| Salt | 1.0 |

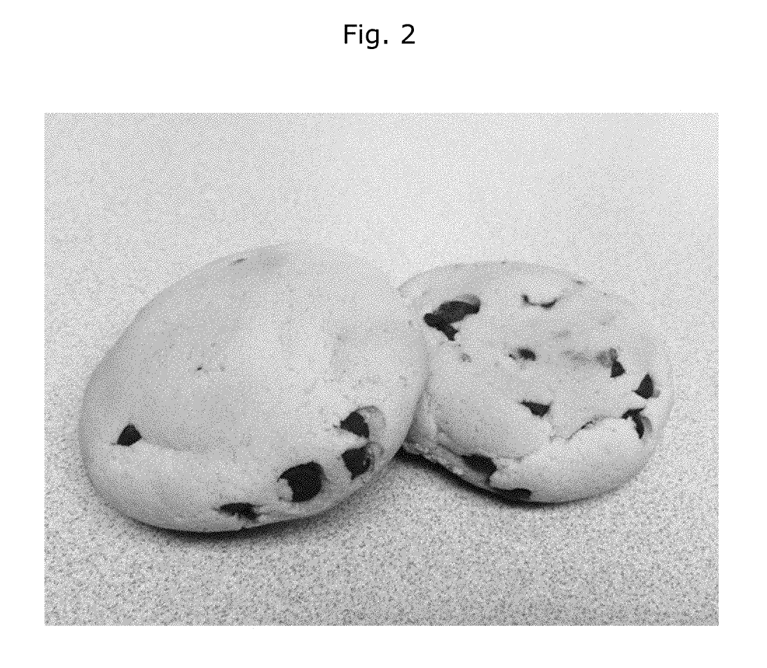

Butter, brown sugar, and vanilla were creamed together in a mixer (KitchenAid® RKP26M1XCU PRO600). The WPPC, acid casein, dry flavorings, baking soda, salt, and sucralose were mixed together and then added to the mixer with the wet ingredients and further mixed on low speed for approximately one minute. When the dough had formed, some of it was taste-tested to determine its taste and consistency of a cookie dough product and some of it was used to form 50-gram balls of dough that were baked at 325 degrees Fahrenheit for 9 minutes to produce cookies, The cookies were cooled, then taste-tested. Both the cookie dough and the cookies were found to have a pleasant taste and consistency, as expected for cookie dough and for cookies. Tables 4-6 list the ingredients used to make flourless cookie dough, flourless and eggless cookie dough, and a shelf-stable, reduced sugar and fat cookie dough, respectively. Ingredients were mixed in a similar manner to that described above, and both cookie dough and cookies produced from the different doughs were evaluated and taste-tested, and found to have a similar pleasant taste and consistency, as expected for cookie dough and for cookies. A photograph of one of the cookies made using this protocol is shown in FIG. 2,

TABLE 4
Flourless Cookie Dough

| Ingredient | Amount (g) |
|---|---|
| White sugar | 150 |
| Brown sugar | 165 |
| Margarine | 226 |
| Vanilla | 5 |
| Egg | 60 |
| Baking soda | 7 |
| Salt | 3 |
| Chocolate chips | 165 |
| Water | 100 |
| WPPC | 200 |

TABLE 5
Flourless & Eggless Cookie Dough

| Ingredient | Amount (g) |
|---|---|
| White sugar | 150 |
| Brown sugar | 165 |
| Margarine | 226 |
| Vanilla | 5 |
| Baking soda | 7 |
| Salt | 3 |
| Chocolate chips | 165 |
| Water | 146 |
| HFWPC | 225 |

TABLE 6
Shelf Stable-Reduced Sugar and Fat
Cookie Dough

| Ingredient | Amount (g) |
|---|---|
| Butter | 70 |
| Brown Sugar | 70 |
| Applesauce | 20 |
| WPPC | 140 |
| Acid Casein | 10 |
| Salt | 1 |
| Sucralose | 1.5 |
| Baking soda | 1.3 |
| Sorbitol | 30 |
| Glycerine | 50 |
| Fiber Syrup | 95 |
| Flavor | 5.5 |

### Cookie Dough and Cookies Produced Using Milk Protein Concentrate (MPC)

Ingredients are listed in Table 7 for a cookie dough made with milk protein concentrate (MPC).

TABLE 7
Cookie Dough Made with Milk Protein Concentrate (MPC)

| Ingredient | Amount (g) |
|---|---|
| Butter | 70 |
| Sugar, Brown | 70 |
| Apple sauce | 15 |
| DP3 Fiber (Iso-maltooligosaccharide) | 95 |
| Syrup | |
| Sorbitol | 30 |
| Glycerine | 50 |
| Milk Protein Concentrate | 140 |
| Acid casein | 10 |
| Vanilla extract | 2.5 |
| Natural and artificial flavors | 3.0 |
| Baking Soda | 1.3 |
| Sucralose | 1.5 |
| Salt | 1.0 |

Butter, brown sugar, and vanilla were creamed together in a mixer (KitchenAid® RKP26M1XCU PRO600). The MPC, acid casein, dry flavorings, baking soda, salt, and sucralose were mixed together and then added to the mixer with the wet ingredients and further mixed on low speed for approximately one minute. When the dough had formed, some of it was taste-tested to determine its taste and consistency of a cookie dough product and some of it was used to form 50-gram balls of dough that were baked at 325 degrees Fahrenheit for 9 minutes to produce cookies. The cookies were cooled, then taste-tested.

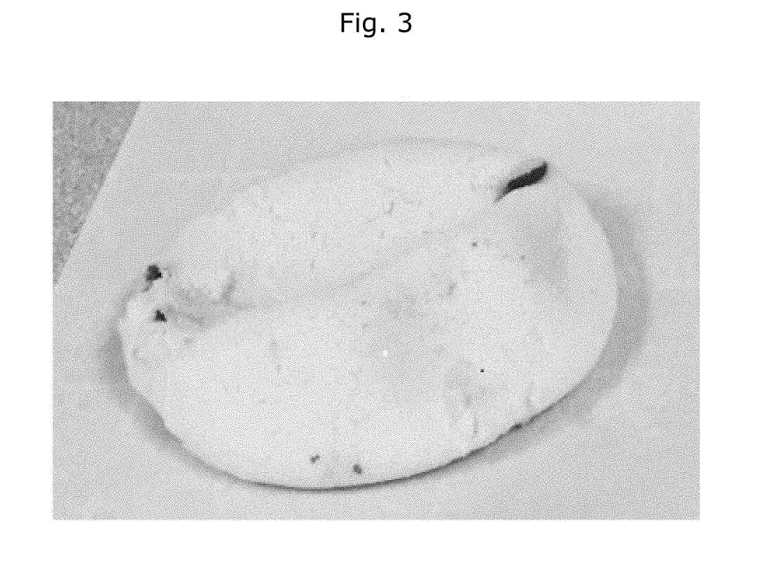

The cookies prepared using MPC did not develop the requisite cookie structure, and completely collapsed, as shown in FIG. 3. Other than the fact that they were round and solid, they did not really seem cookie-like texturally when taste-tested. The use of MPC also produced undesirable flavor, the flavor coming through very strongly, as compare to the cookies produced using WPPC, which had a much more subtle and clean-tasting flavor.

The MPC-based cookie doughs were sandy in texture, lacked density, and were generally significantly different from what one would expect of a cookie dough—lacking the cohesion, chewiness, etc. of a typical cookie dough.

What is claimed is:

1. A whey protein-enriched cookie dough comprising whey protein phospholipid concentrate.

2. The whey protein-enriched cookie dough of claim 1 wherein the dough comprises at least about 18 percent of a whey protein ingredient by weight, the whey protein ingredient comprising at least about 50 percent whey protein phospholipid concentrate.

3. The cookie dough of claim 2 wherein the whey protein ingredient comprises at least about 75 percent whey protein phospholipid concentrate.

4. The cookie dough of claim 2 wherein the whey protein ingredient comprises at least about 95 percent whey protein phospholipid concentrate.

5. The whey protein-enriched cookie dough of claim 1 wherein the cookie dough is eggless.

6. The whey protein-enriched cookie dough of claim 1 wherein the cookie is flourless.

7. An eggless shelf-stable cookie dough, the cookie dough comprising whey protein phospholipid concentrate and at least one non-viscous soluble fiber.

8. The eggless shelf-stable cookie dough of claim 7 wherein the non-viscous soluble fiber is added to the cookie dough as a syrup.

9. The eggless shelf-stable cookie dough of claim 7 wherein the whey protein phospholipid concentrate is present in the cookie dough in an amount of at least about 18 percent by weight of the cookie dough.

10. A method for making a protein-enriched cookie dough comprising whey protein, the method comprising adding to an admixture of dough ingredients at least about 18 percent of a whey protein ingredient by weight of the dough, the whey protein ingredient comprising at least about 50 percent whey protein phospholipid concentrate by weight.

11. A whey protein-enriched cookie comprising whey protein phospholipid concentrate.

12. The whey protein-enriched cookie of claim 11 wherein the whey protein phospholipid concentrate comprises at least about 50 percent by weight of a whey protein component added as an ingredient to a dough from which the cookie is made, the whey protein component being at least about 18 percent by weight of the dough.

13. The whey protein-enriched cookie of claim 11 wherein the dough is eggless.

14. The whey protein-enriched cookie of claim 11 wherein the dough is flourless.

15. An eggless shelf-stable cookie, the cookie comprising whey protein phospholipid concentrate and at least one non-viscous soluble fiber.

16. The eggless shelf-stable cookie of claim 15 wherein the whey protein phospholipid concentrate is present in an admixture of cookie dough ingredients in an amount of at least about 18 percent by weight of the cookie dough.

17. A method for making a protein-enriched cookie comprising whey protein, the method comprising adding to an admixture of dough ingredients at least about 18 percent of a whey protein ingredient by weight, the whey protein ingredient comprising at least about 50 percent whey protein phospholipid concentrate.
